(19) United States
(12) Patent Application Publication
(10) Pub. No.: US 2016/0171173 A1
(43) Pub. Date: Jun. 16, 2016

(54) METHOD OF INDENTIFYING NEW USES OF KNOWN DRUGS

(71) Applicant: THE RESEARCH FOUNDATION OF THE CITY UNIVERSITY OF NEW YORK, New York, NY (US)

(72) Inventor: Lei Xie, New York, NY (US)

(21) Appl. No.: 14/907,309

(22) PCT Filed: Jul. 23, 2014
(86) PCT No.: PCT/US14/47751

§ 371 Date: Jan. 25, 2016

Related U.S. Application Data
(60) Provisional application No. 61/857,512, filed on Jul. 23, 2013.

(51) Int. Cl. G06F 19/00; G06F 17/30

(52) U.S. Cl. CPC G06F 19/3443; G06F 17/30864

(57) ABSTRACT

A method for identifying new uses of known drugs is disclosed. The method queries a database of known drugs for a query drug and finds a second drug with a similar structure. A database of proteins is queried to identify proteins that are known to bind to the second drug. A second similarity query finds other proteins that are structurally similar to the proteins known to bind to the second drug. The query drug is then identified as having a potential match with regard to these structurally similar proteins despite those proteins having no known binding affinity for the query drug.

### CROSS-REFERENCE TO RELATED APPLICATIONS

This application is a non-provisional of U.S. Patent Application Ser. No. 61/857,512 (filed Jul. 23, 2013), the entirety of which is incorporated by reference.

### BACKGROUND OF THE INVENTION

The subject matter disclosed herein relates to identifying similarities between drugs and/or proteins and identifying new uses of known drugs.

Rational drug design is traditionally characterized as a “one gene, one drug, one disease” approach where target specificity and a good safety profile a key aims. Unfortunately, this approach has bought limited success and explains, in large part, the current crisis in the pharmaceutical industry. Intuitively this is not surprising because, for example, a drug is unlikely to bind to only a single target. A new approach to drug design is therefore desired.

The discussion above is merely provided for general background information and is not intended to be used as an aid in determining the scope of the claimed subject matter.

### BRIEF DESCRIPTION OF THE INVENTION

A method for identifying new uses of known drugs is disclosed. The method queries a database of known drugs for a query drug and finds a second drug with a similar structure. A database of proteins is queried to identify proteins that are known to bind to the second drug. A second similarity query finds other proteins that are structurally similar to the proteins known to bind to the second drug. The query drug is then identified as having a potential match with regard to these structurally similar proteins despite those proteins having no known binding affinity for the query drug. An advantage that may be realized in the practice of some disclosed embodiments of the method is that new uses of known drugs can be identified.

Disclosed in this specification is a method for identifying a new use for a query drug. The method comprising querying a drug database for a query drug, wherein the drug database comprises chemical similarity data concerning a plurality of drugs including the query drug and a first drug. A degree of chemical similarity between the query drug and the first drug is determined by evaluating the chemical similarity data for the query drug relative to the first drug. The query drug and the first drug are deemed are sufficiently similar if the degree of chemical similarity is within a first predetermined threshold. If the query drug and the first drug are deemed sufficiently similar then identifying a first protein known to bind to the first drug is identified by querying a protein database, wherein the protein database comprises chemical similarity data concerning the first protein. A degree of chemical similarity between the first protein and a plurality of second proteins in the protein database is determined by evaluating the chemical similarity data concerning the first protein relative to each protein in the plurality of second proteins. Candidate proteins from the plurality of second proteins are selected when the degree of chemical similarity is within a second predetermined threshold. A statistical significance test between the query drug and the candidate proteins is performed, wherein a matching protein is determined if a drug-protein p-value is 0.05 or less. If a matching protein is determined then known biological use of each matching protein is identified. The known biological use is then identified as a use for the query drug.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a schematic depiction of a conventional method for fitting a drug to a binding pocket of a peptide;

FIG. 2 is a schematic depiction of a method for identifying a new target peptide for a known drug based on a similarity score between the new target peptide and peptides known to bind to the known drug;

FIG. 3 is a schematic depiction of a method for identifying a new drug for binding to the new target peptide; and

FIG. 4 is a schematic depiction of a data structure comprising a protein database and a drug database.

### DETAILED DESCRIPTION OF THE INVENTION

Rooted in the underlying functional promiscuity and evolutionary linkage of proteins, drugs commonly interact with not only their intended protein target (on-target), but also multiple (sometimes even hundreds) of other proteins (off-targets), across organisms and across protein space. On average, an active drug could interact with approximately 6.3 protein targets in the existing druggable genome, which only accounts for about 5% of the human genome. If drug interactions with the entire genomes are considered, many unexpected off-targets could exist. These multiple drug-target interactions may not only cause drug side effects but also contribute to therapeutic effects. The identification of genome-wide off-targets provides new opportunities to reuse existing drugs for new clinical indications (drug repurposing), and design efficient multi-target therapeutics (polypharmacology)—which have only been serendipitously discovered in the past.

The disclosed method provides a capability to connect bioactive compounds to whole genomes of multiple organisms, including humans and pathogens. The method facilitates the transformation of conventional “one-drug-one-target” drug discovery process to a new paradigm of systems pharmacology. The method permits prediction of side effects at an early stage, permits reusing of old drugs to treat new diseases and identifies molecular targets of bioactive compounds from phenotypic screening, designing new anti-infectious therapeutics to combat drug resistance and facilitating the development of personalized medicines. The method may also provide a systems pharmacology paradigm for drug discovery. Systems pharmacology focuses on searching for multi-target drugs to perturb diseased-associated networks rather than designing a selective ligand to target an individual receptor. However, identifying genome-wide multiple targets for a drug is a complex and challenging task. The disclosed methods help the identifying by being able to identify potential interactions between a bioactive compound and multiple proteins for multiple organisms.

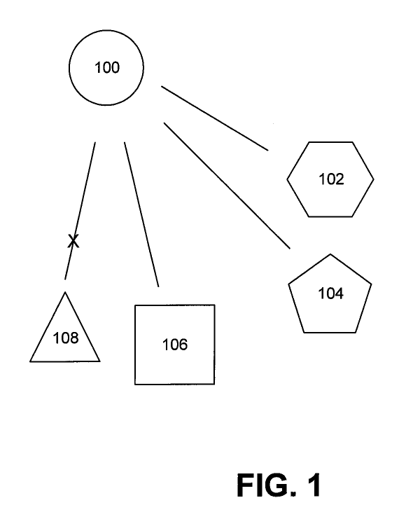

FIG. 1 depicts a conventional method. A database is queried by supplying structural information about a drug 100. The drug 100 is fitted into individual proteins 102, 104 and 106 to determine if the drug 100 will bind to any one of the proteins 102, 104, 106 and 108. In the exemplary embodiment of FIG. 1, binding is predicted between the drug 100 and proteins 102, 104 and 106 based on structural fitness between the drug 100 and known binding sites on proteins 102, 104 and 106. The protein 108 lacks any corresponding known binding sites that fit with the drug 100, so the protein 108 is not predicted to bind with the drug 100.

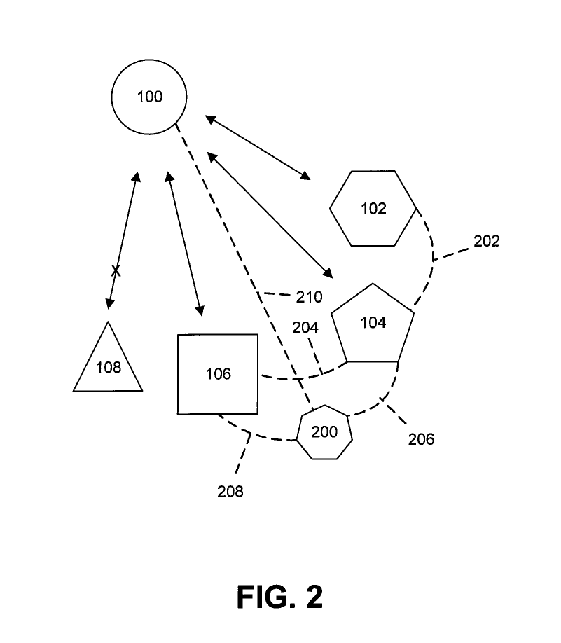

FIG. 2 depicts one embodiment of the disclosed method. In this disclosed method, a protein database is queried to identify similarities 202 between proteins 102 and 104. See, for example, an article by L. Xie entitled Detecting evolutionary relationships across existing fold space, using sequence order-independent profile-profile alignments appearing in Proceeding of the National Academy of Sciences of the United States of America, volume 105, number 14, pages 5441-5446. These similarities may explain why both proteins 102, 104 bind to the drug 100. Likewise, similarities 204 are found between the proteins 104 and 106. A first new similarity 206 is found between the protein 104 and a new protein 200. Likewise, a second new similarity 208 is found between protein 106 and the new protein 200. A potential interaction 210 between the drug 100 and the new protein 200 has been identified that was not identified in the conventional method of FIG. 1. The conventional method only considers the local similarity between the query drug and the other chemicals, or query protein with other proteins in the database, respectively. In contrast, the disclosed method links the drugs and proteins into a network so that similarities can be inferred by exploring global topology of integrated chemical similarity and protein similarity networks. In one embodiment, a random walk algorithm with a restart algorithm is used to calculate the graphic distance between two compounds (either drugs or proteins) in the network. Millions of bioactive compounds, including drugs and proteins, from bioassay databases may be linked into a chemical similarity network using a chemical similarity measurement.

### Drug Similarity Scoring

The term “drugs” generally refers to bioactive molecules including both peptides and non-peptide molecules. Drug similarity may be represented using multiple types of orthogonal molecular descriptors, as different descriptors have different information content, suitable for different tasks. These descriptors include, but are not limited to, extended connectivity fingerprints, the size of common substructures, path-based fingerprint and predefined key, and pharmacophores. The similarity between molecular descriptors may be determined using various measurements such as distance coefficients (e.g. mean Euclidean etc.) and association coefficients (e.g. Tanimoto etc.).

Given a query drug, the query drug is linked to the drug similarity network by the chemical similarity. Graph algorithms, such as a Random Walk with Restart (RWR), may be applied to perform a probabilistic traversal of integrated chemical and protein similarity network, across all paths leading away from the query to the proteins. The probability of choosing a path will be proportional to the similarity. In one embodiment, the output of the algorithm is the list of all proteins in the network (or a subset thereof), ranked by the probability pᵢ for the query chemical to reach the protein i. Graph mining algorithms may be implemented using big data technique Apache Spark which provides primitives for in-memory cluster computing.

The graphic similarity scores are normalized and their statistical significances are assessed. Drugs may be grouped into ligand sets based on their target proteins. The score distribution of a ligand set is compared with that of a randomly drawn set of the same size. The ligand set statistics include Kolmogorov Smirnov statistic, the sum, the mean, or the median of the (transformed) similarity score, maxmean statistic, and Wilcoxon rank sum test statistic. To assess significance, the target label of the ligand sets is permuted a large number of times (e.g. 1000 or more) and then the ligand set statistics are re-compute. The p-value is the fraction of permuted ligand set statistics that exceeds the observed value. As the permutation test is relatively time-consuming, efficient random-set methods may be applied for the parametric approximation of the null distribution. The random-set method compares the enrichment of a ligand set (size=m) with the enrichment of all other distinct randomly drawn sets of size m from N chemicals in the newtork. The distribution of the mean of the similarity score of the sets of size m can be approximated with a normal distribution with mean and variance that depend on N and m.

A two-step procedure for the significance assessment may be implemented. The random-set method is first applied to filter out less significant hits, so only significant hits will be subject to the permutation test. To control false positives, the p-value is adjusted by false discovery rate (FDR) using Benjamini-Hochberg procedure.

### Protein Similarity Scoring

Drug binding pocket similarity between two proteins may be determined by sequence order independent profile-profile alignment (SOIPPA), even if these two proteins do not have similar global shape. The rationale is that similarity binding pocket will bind to similar drugs. An example is protein steroid delta-isomerase and estrogen receptor alpha. Although the global structure of these two proteins have completely different shape, they have similar binding pocket (similarity score 0.82 with p-value=4.09e-6, it is considered as significantly similar if p-value<0.05). Both of delta-isomerase and estrogen receptor alpha can bind to estradiol and its analogs.

Sequence similarity may be determined using local sequence alignment (e.g. using Position-Specific Iterative Basic Local Alignment Search Tool (PSI-BLAST)) to detect common motifs and may also be assessed by their common sequence feature (e.g. frequency, distribution, and packing of cysteine residues within the sequence). For example, all protein kinases can be clustered based on the sequence alignment of ATP binding sties.

Functional similarity is evaluated by semantic similarity of Gene Ontology (GO) terms. GO is a set of controlled terms that are used to annotate the function of proteins. The GO terms are organized as a direct acyclic graph (DAG). The functional similarity between two proteins may be determined by comparing their corresponding DAG. For example, the GO annotation of steroid delta-isomerase are “steroid metabolic process” and “transport.” The GO annotation of estrogen receptor alpha are “response to estradiol”, “regulation of transcription”, etc. Their GO similarity is 0.37.

Each type of similarity measurement generates a protein-protein similarity network. This strategy is applied to target proteins to generate a set of protein-protein similarity networks based on these similarity measurements. A drug-target coherent ranking is assessed for each pair of drug-drug and protein-protein similarity networks. The multiple coherent ranking score is combined into a single drug-target association score by using a Bayesian network or similar machine learning approach.

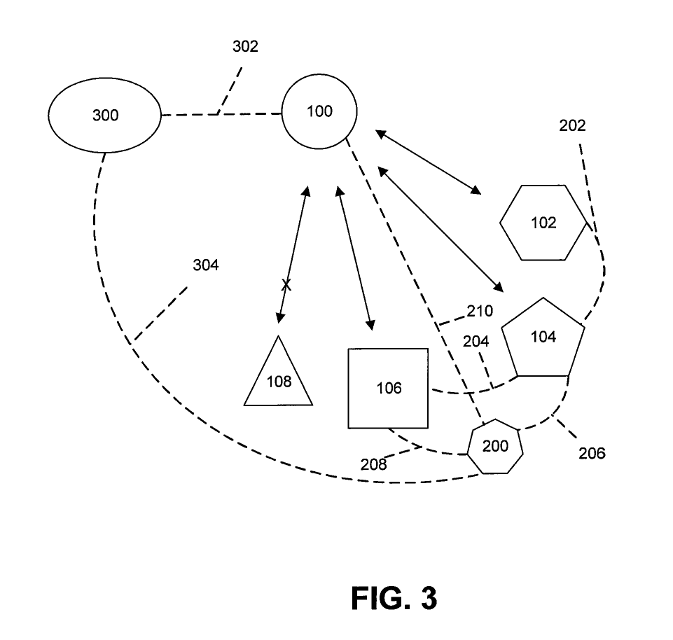

FIG. 3 depicts another embodiment of the disclosed method. A statically significant similarity 302 was identified between the drug 100 and a drug 300. Due to the identification of similarities 206, 208, the drug 300 is a potential interaction 304 between the drug 300 and the new protein 200. The conventional method fails to detect such potential interactions.

In the embodiment of FIG. 3, a drug database is queried for a query drug 300, wherein the drug database comprises chemical similarity data concerning a plurality of drugs including the query drug 300 and a first drug 100. A degree of statically significant chemical similarity 302 between the query drug 300 and the first drug 00 is determined by evaluating the chemical similarity data for the query drug 300 relative to the first drug 100. The query drug 300 is deemed sufficiently similar to the first drug 100 if the degree of chemical similarity is within a first predetermined threshold (e.g. similarity score greater than 0.90). If the query drug 300 and the first drug 100 are deemed sufficiently similar, proteins 102, 104, 106, known to bind to the first drug 100 are identified. Degrees of chemical similarity (e.g. similarities 204) between the proteins in the protein database are determined. For example, a first protein 104 and a plurality of second proteins 102, 106, 200 may have their degrees of chemical similarities determined. From this, a candidate protein 200 is selected, where the candidate protein 200 is not known to bind to the first drug 100. This selection may be made when the degree of chemical similarity (e.g. similarity 206, 208) is within a predetermined threshold. A statistical significance test is performed between the query drug 300 and the candidate proteins (including protein 200), wherein a matching protein is determined if a p-value is 0.05 or less. If a matching protein is determined, the query drug 300 may be identified as having possibility activity on the matching protein 200.

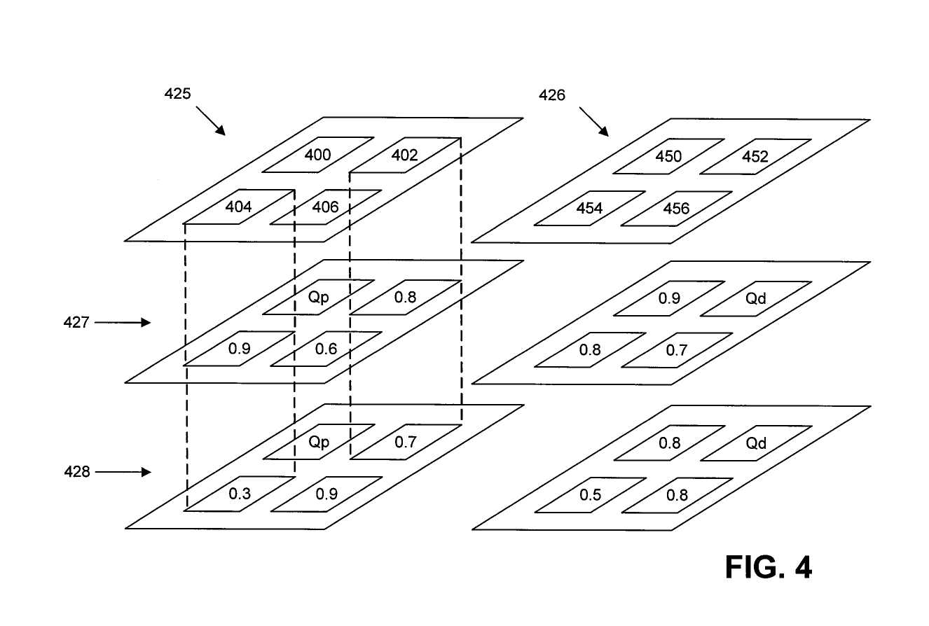

FIG. 4 is a schematic depiction of an exemplary data structure. The data structure comprises a protein database 425 and a drug database 426. The protein database 425 comprises proteins that provide a binding pocket. The drug database 426 comprises organic molecules, including peptides, that fit within a binding pocket to elicit a biological effect. In the exemplary embodiment of FIG. 4 the proteins and the drugs each have sequence characteristics (e.g. both may be amino acid sequences) such that each database has respective sequence values 427 and structure values 428. For example, the protein 402 has a sequence value of 0.8 and a structure value of 0.7. In a similar fashion, drug 450 has a sequence value of 0.9 and a structure value of 0.8. The protein 400 has a sequence value and structure value denoted by Qp (e.g. tyrosinase, a protein involved in cancer) while drug 452 has a sequence value and structure value denoted by Qd (e.g. a therapeutic peptide). Protein database 425 depicts proteins 400, 402, 404 and 406, each of which has respective sequence values and respective structure values. Likewise, the drug database 426 depicts drugs 450, 452, 454 and 456, each of which has respective sequence values and respective structure values. In other embodiments, the drug is a small molecule that does not have sequence characteristics but has structural characteristics. For example, the drug may be an organic molecule that is amino acid-free. Within a given database the differences in values can be determined. For example, the difference in the sequence values and structure values for certain proteins or drugs is illustrated in Table 1.

TABLE 1

| Comparison | Sequence Difference | Structure Difference |
|---|---|---|
| Protein 402 − Protein 406 | \|0.8 − 0.6\| = 0.2 | \|0.7 − 0.9\| = 0.2 |
| Protein 402 − Protein 404 | \|0.8 − 0.9\| = 0.1 | \|0.7 − 0.3\| = 0.4 |
| Protein 406 − Protein 404 | \|0.6 − 0.9\| = 0.3 | \|0.9 − 0.3\| = 0.6 |

A similarity score may be derived using the differences in Table 1. For example, a sequence similarity score of 0.9 for proteins 402, 404 may be derived from |0.8−0.9|=0.1 according to the equation 1.0−0.1=0.9. Likewise, a structure similarity score of 0.6 for proteins 402, 404 may be derived from |0.7−0.3|=0.4 according to the equation 1.0−0.4=0.6. Both sequence values and structure values (and other values, not shown) may be integrated by a Bayesian network into a single similarity score.

While FIG. 4 only depicts two features of comparison (sequence value and structure value) other features are contemplated for use with the disclosed method. For query protein 400 and query drug 452, their relations to other nodes in the network may be scored by, for example, a random walk algorithm. Multiple evidences are integrated by, for example, a Bayesian network. For example, the differences in both sequence values and structure values may be integrated by a Bayesian network into a single similarity score.

Drug similarity network (e.g. drug database 426) and protein similarity network (e.g. protein database 425) are connected between a given drug and a given protein if they are known to interact with each other.

### EXAMPLE

In the following example Raloxifene, a safe pharmaceutical for osteoporosis, is queried for potential new uses beyond osteoporosis.

In this example, Raloxifen has a similarity score of 0.95 relative to a selective estrogen receptor modulator LLB, which is known to bind to human estrogen receptor alpha (ERalpha).

In the present example, a predetermined threshold of 0.90 was established such that only similarity scores above this predetermined threshold were deemed sufficiently similar. Because the Raloxifen and the LLB have a similarity score that satisfies the threshold, they are deemed sufficiently similar.

As previously discussed, human estrogen receptor alpha (ERalpha) is known to bind to the LLB. Using this known binding to identify ERalpha, a protein database is queried for ERalpha wherein the protein database comprises similarity data concerning ERalpha and other proteins. A degree of chemical similarity is determined between the ERalpha and the other proteins by evaluating their similarity data. Matching proteins are selected when the degree of chemical similarity is within a predetermined threshold.

In the present example a protein PhzB in microbial Pseudomonas aeruginosa was determined to have a similarity score of 0.90, which was within a predetermined protein similarity threshold (e.g. 0.85 and greater). The similarity was due, at least in part, to a binding site similarity between human ERalpha and the protein PhzB. Other matching proteins, which are also above the predetermined threshold, may also be determined in this step. PhzB may be only one protein that satisfies the predetermined protein similarity threshold and may therefore be one protein on a list of matching proteins.

A statistical significance test is performed between Raloxifene and the matching proteins. Raloxifene is linked to PhzB with a statistical significant p-value<0.01 via Random Walk on the integrated chemical and protein similarity network. In one embodiment, statistical significance is determined when the p-value is 0.05 or less. In another embodiment, statistical significance is determined when the p-value is 0.01 or less.

PhzB is a protein that causes disease symptom in humans. The inhibition of PhzB will make microbes not infectious, thus no harm to humans. Because there is a statistically significant link between Raloxifene and PhzB, Raloxifene, may be repurposed to target PhzB as an anti-infectious agents for drug-resistant bacteria.

In view of the foregoing, embodiments of the invention identify similarities between drugs and/or proteins and use these similarities to identify potentially useful drugs. A technical effect of some embodiments is to identify new protein targets for known drugs. A technical effect of some other embodiments is to identify new drugs for known protein targets.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a non-transient computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for identifying a new use for a query drug, the method comprising steps of:
querying a drug database for a query drug, wherein the drug database comprises chemical similarity data concerning a plurality of drugs including the query drug and a first drug;
determining a degree of chemical similarity between the query drug and the first drug by evaluating the chemical similarity data for the query drug relative to the first drug;
deeming the query drug and the first drug are sufficiently similar if the degree of chemical similarity is within a first predetermined threshold;
wherein, if the query drug and the first drug are deemed sufficiently similar:
identifying a first protein known to bind to the first drug by querying a protein database, wherein the protein database comprises chemical similarity data concerning the first protein;
determining a degree of chemical similarity between the first protein and a plurality of second proteins in the protein database by evaluating the chemical similarity data concerning the first protein relative to each protein in the plurality of second proteins;
selecting candidate proteins from the plurality of second proteins when the degree of chemical similarity is within a second predetermined threshold;
performing a statistical significance test between the query drug and the candidate proteins, wherein a matching protein is determined if a drug-protein p-value is 0.05 or less;
wherein, if a matching protein is determined:
identifying a known biological use of each matching protein;
identifying the known biological use as a use for the query drug.

2. The method as recited in claim 1, wherein the query drug is a non-peptide organic molecule.

3. The method as recited in claim 1, wherein the query drug is a peptide.

4. The method as recited in claim 1, wherein the protein database comprises chemical similarity data including sequence order independent profile-profile alignment similarity data.

5. The method as recited in claim 1, wherein the statistical significance test comprises a random walk algorithm with a restart algorithm executed by a computer.

6. The method as recited in claim 1, wherein the step of determining the degree of chemical similarity between the first protein and the plurality of second proteins includes determining functional similarity by semantic similarity of Gene Ontology (GO) terms.

7. The method as recited in claim 1, wherein the step of determining the degree of chemical similarity between the first protein and the plurality of second proteins includes determining sequence similarity using local sequence alignment.

8. The method as recited in claim 1, wherein the step of determining the degree of chemical similarity between the first protein and the plurality of second proteins includes using a random walk with restart algorithm to determine a protein p-value.

9. The method as recited in claim 1, determining the degree of chemical similarity between the query drug and the first drug includes using a random walk with restart algorithm to determine a drug p-value.

10. A method for identifying a new use for a query drug, the method comprising steps of:
querying a drug database for a query drug, wherein the drug database comprises chemical similarity data concerning a plurality of drugs including the query drug and a first drug;
determining a degree of chemical similarity between the query drug and the first drug by evaluating the chemical similarity data for the query drug relative to the first drug;
deeming the query drug and the first drug are sufficiently similar if the degree of chemical similarity is within a first predetermined threshold;
wherein, if the query drug and the first drug are deemed sufficiently similar:
identifying a first protein known to bind to the first drug by querying a protein database, wherein the protein database comprises chemical similarity data concerning the first protein;
determining a degree of chemical similarity between the first protein and a plurality of second proteins in the protein database by evaluating the chemical similarity data concerning the first protein relative to each protein in the plurality of second proteins;
selecting candidate proteins from the plurality of second proteins when the degree of chemical similarity is within a second predetermined threshold;
performing a statistical significance test between the query drug and the candidate proteins, wherein a matching protein is determined if a drug-protein p-value is 0.05 or less, wherein the statistical significance test comprises a random walk algorithm executed by a computer;
wherein, if a matching protein is determined:
identifying a known biological use of each matching protein;
identifying the known biological use as a use for the query drug.

11. The method as recited in claim 10, wherein the query drug is a non-peptide organic molecule.

12. The method as recited in claim 10, wherein the query drug is a peptide.

13. The method as recited in claim 10, wherein the protein database comprises chemical similarity data including sequence order independent profile-profile alignment similarity data.

14. The method as recited in claim 10, wherein the statistical significance test comprises a random walk algorithm with a restart algorithm executed by a computer.

15. The method as recited in claim 10, wherein the step of determining the degree of chemical similarity between the first protein and the plurality of second proteins includes determining functional similarity by semantic similarity of Gene Ontology (GO) terms.

16. The method as recited in claim 10, wherein the step of determining the degree of chemical similarity between the first protein and the plurality of second proteins includes determining sequence similarity using local sequence alignment.

17. The method as recited in claim 10, wherein the step of determining the degree of chemical similarity between the first protein and the plurality of second proteins includes using a random walk with restart algorithm to determine a protein p-value.

18. The method as recited in claim 10, determining the degree of chemical similarity between the query drug and the first drug includes using a random walk with restart algorithm to determine a drug p-value.
